(19) United States
(12) Patent Application Publication
(10) Pub. No.: US 2017/0128157 A1
(43) Pub. Date: May 11, 2017

(54) DENTAL HAND TOOL

(71) Applicant: Ivoclar Vivadent AG, Schaan (LI)

(72) Inventors: Frank MÜLLER, Feldkirch (AT); Nora Christina Walther, Oberriet (CH)

(21) Appl. No.: 15/047,913

(22) Filed: Feb. 19, 2016

(30) Foreign Application Priority Data
Nov. 9, 2015 (EP) 15193647.3

(51) Int. Cl. A61C 3/08; A61C 1/12; A61C 5/04

(52) U.S. Cl. CPC A61C 3/08; A61C 5/04; A61C 1/12

(57) ABSTRACT

The dental hand tool is arranged with a handle comprising at least a connector and a coupling member at one end thereof. The dental hand tool is in particular provided with a second connector and a second coupling member at the other end of the handle. A modeling tip (30) is provided that comprises a shaft and that is suitable for the coupling member. The modeling tip comprises a coating of a material that is more flexible compared to the remaining material of the modeling tip. In particular, the material has a smaller surface energy compared to the remaining material of the modeling tip.

### CROSS-REFERENCE TO RELATED APPLICATIONS

This present application claims priority to European patent application No. 15193647.3 filed on Nov. 9, 2015, the disclosure of which is incorporated herein by reference in its entirety.

### TECHNICAL FIELD

The invention relates to a dental hand tool as claimed in the preamble of claim 1.

### BACKGROUND OF THE INVENTION

Dental hand tools that are also referred to as dental manual instruments, have been known for a long time. Such hand tools are either formed in one piece or comprise replaceable tips, for example modeling tips. The tips are typically bent or offset, for example according to the manner of a swan neck, in order to enable the dentist to also work at positions that face away from the mouth opening of the patient, namely at distal areas of teeth or tooth interspaces of molars, respectively.

It has been known for a long time that the operability can be improved by using differently bent tips, wherein it is also known to provide tips for various purposes, therefore for example to provide spoon tips, spade tips, tips for filing and the like in order to take account of the various necessary processing steps by the dentist.

It is to be understood that the tip even under the application of pressure must not get lost in the mouth of the patient (danger of suffocation). Moreover, it is frequently desired to be able to exert a considerable pressure such that a safe guidance of the tip by means of a coupling member is preferred.

One more recent example for such a solution becomes apparent from U.S. Pat. No. 4,552,531 A1, which is incorporated herein by reference. With this solution, the tip is held in a blind hole by friction, which blind hole is formed as a coupling member at the end side of a connector of the dental hand tool. A snap-on connection is provided and the diameter of the tip following a shaft is slightly enlarged.

This solution, indeed, permits to exert significant forces by the dentist, and also a safe mounting of the tip on the dental hand tool. The coupling member on the other side, provides a blind hole that is deep-seated and difficult to clean such that bacterial contamination accumulates there without regular autoclaving.

Typically, dental hand tools among other things are also used for the filling and modeling of filling materials. For the filling it is favorable to use a spherical tip, for example according to U.S. Pat. No. 6,206,698 A1, which is incorporated herein by reference. Contrary to that it is favorable to use a finer tip for modeling in order to be able to provide the necessary precision. Moreover, especially with fillings in the posterior teeth region, it is necessary for the dental hand instruments to sustain larger shear forces, for example for the configuration of the cusp incline. In this respect, the use of metallic modeling tips according to the above-mentioned reference U.S. Pat. No. 4,552,531 A1 has generally proven successful, wherein, however, depending on the curing condition of the dental restoration part the modeling tip partially sticks together with the restoration material.

In order to take account of these two different requirements, typically at least two different types of dental hand tools are kept at hand in the dental office, and moreover in different configurations, respectively.

### SUMMARY OF THE INVENTION

Contrary to this, the invention is based on the object of providing a dental hand tool as claimed in the preamble of claim 1 that may be used more universally, in particular both for the modeling and for modeling-close operations of the dentist, is easier to handle, but nevertheless does not encounter any sanitary concerns.

This object is inventively solved by claim 1. Advantageous further developments emerge from the subclaims.

According to the invention it is provided that a dental hand tool comprises a modeling tip that predominantly consists of a hard material such as a hard plastic material. The front area of the modeling tip is provided with a coating which is softer compared to the core of the modeling tip. In the area of the coating the configuration is spherical, and preferably the core with its front end protrudes from the modeling tip.

Through this by means of a lateral application of pressure in the area of the coating, a filling or condensing effect may be achieved. The short protruding end of the core enables a fine modeling and chiseling. It is especially favorable to form the coating from an elastomer that comprises a low surface energy, a low tendency for wetting and excellent non-stick properties.

It is preferred that the modeling tip is constructed as a two-component part that combines a rigid core made of a hard carrier plastic with a substantially uniform thin layer of a non-adhesive elastomer.

The material of the coating is selected so that it comprises an especially small surface energy. It preferably is less than 35 mN/m. The material is preferably selected so that the tendency for wetting is exceptionally small. Suitable materials in this respect include elastomers, silicone, PTFE but also for example a polyolefin. If a foamed material is used as the material for the coating, it is preferred to use a closed-cell foam. The surface layer of the foam can also be redensified so that it is bubble-free.

One configuration with an especially resilient or flexible coating, combined with a fine core tip is surprisingly especially favorable if both modeling tasks and filling tasks are to be handled with the same modeling tip.

The thickness of the coating may for example amount to 0.15 to 0.25 mm. It is uniform, but decreases at the front end thereof.

The core protrudes from the coating at the front end thereof approximately 0.25 to 0.75 mm, preferably 0.5 mm. This enables a precise modeling especially of dental materials made from a composite.

Surprisingly, this configuration makes it possible to prevent the modeling tip from sticking or adhering to the composite, although there is some—even though small—contact between the core of the tip and the composite.

The small layer thickness of the coating also permits a good reproduction of the arising shear forces so that also very delicate anatomic dental structures may be designed.

The inventive coating is not limited to the use of elastomers. Instead, for example also a coating made of polytetrafluoroethylene may be used, or a coating made of any other material that is considerably softer than the material of the core.

Thus, it is also possible to substantially form the coating from a closed-cell foam the outer surface of which is particularly smoothed, for example due to thermal exposure.

It is particularly favorable if a connector of the dental hand tool is provided for the connection with a special coupling member. The connector may then comprise two offsets opposite to one another. The coupling member preferably extends in such a manner that an angle of approximately 90 degrees extends from the last portion of the connector to the coupling member. In this respect, the coupling member comprises a ring that accommodates the shaft of the modeling tip that passes through the ring.

Preferably a primary offset, a secondary offset and a third offset are provided. The offset angles thereof are opposite to one another. It is preferred that the third offset angle is comparably large, for example larger than 60 degrees. The last short portion of the connector beyond the third offset may extend transversely to the ring of the coupling member, or in the extension of the area of the third offset—so that an extensive total offset is possible, as it is particularly favorable with works at distal regions of molars.

This not only permits a safe removal of the modeling tip, namely by exerting a pressure on the rearward region of the shaft, but also a contamination-poor and easy-to-clean implementation of the coupling member. Such a coupling member may be cleaned and sterilized much easier than a blind hole.

Moreover, this design practically is a precondition for the implementation of the modeling tip with a non-adhesive coating. A modeling tip having a non-stick coating barely cannot be pulled out, but possibly may be pressed out of the coupling member. Due to the flexibility or resilience of the coating, together with the smooth surface thereof, a significant reduction of the coefficient of static friction is produced, resulting in the desired effect that the treated composite does not adhere at this location.

Due to the small surface of the exposed core tip of clearly less than 0.5 mm², there neither is a tendency of the composite material to adhere at this position, so that the inventive modeling tip is especially suitable for a non-stick modeling process.

The region of the coating of the modeling tip is typically formed to be slightly spherical or ball-shaped. This may for example be realized by the fact that a front region of the modeling tip that is also referred to as work area, subsequent to the coupling at first runs cylindrically and then ends in a conical region. Between these regions there is a spherical transition area that can be especially well used for filling operations.

In an advantageous embodiment of the invention it is provided that the inventive dental hand tool is provided with two coupling members at the end sides thereof in a manner known per se, which coupling members enable a different offset angle of the modeling tip. Hereby, it is possible to easily work at different locations within the mouth of the patient with the same hand tool.

Moreover, it is particularly favorable if one of the offsets is formed immediately at the ring of the coupling member. This allows a particularly well accessibility of the distal regions of posterior teeth and of tooth interspaces with a small dimension. This is advantageous in confined oral cavities, but also has a favorable effect for patients which feel uncomfortable with treatments in the lingual area; due to the short inventive application dimension retching can be reduced compared to the state of the art.

It is particularly favorable that the inventive modeling tip designed as a disposable element may take account of the highest standards of hygiene in a cost-effective and material-saving manner. The cleaning of the coupling member and of the connector of the dental hand tool is possible without causing any problems due to the fact that there are no sharp inner edges. Contrary to that, the inventive ring is preferably spherical and easy to clean.

It is especially favorable that the design of the inventive modeling tip is so that the more flexible or resilient material wraps a core that is harder compared thereto. The wrapping or coating preferably has a uniform coating thickness. This offers the advantage that the flexibility or resilience of the outer surface of the modeling tip is as well identical at all locations at which the coating thickness is identical.

Typically, both the core and the coating taper conically towards the front end. Due to the tapered shape at this location, the flexibility or resilience of the core is larger due to the smaller material use. The flexibility of the coating may therefore decrease as well so that in this respect a tapering coating is favorable.

The coating thus not only enables a well and favorable modeling with an insignificant tendency for adhesion, but also a precise handling of even fine modeling operations on the front end.

It is preferred that the front end of the core protrudes from the coating. At this location, the diameter of the core only amounts to 0.3 mm. The front tip may end in a small radius, for example 0.05 mm. This also enables the formation of possibly desired fissures at the occlusal surface, or other post-treatments such as the preparation for the removal of excess material.

Surprisingly, it is favorable in this respect that the inventive modeling tip may combine the advantages of a wedge-shaped design with a smoothing function.

In a preferred embodiment, the inventive modeling tip is formed to have circular symmetrical form. In a modified embodiment it is configured in the manner of a sharp spoon. With its spherical bottom side it is also possible to ensure a good levelling and smoothing function with this solution, although that does not rule out to nevertheless be able to perform a comparably sharp-edged treatment with the aid of the front end thereof.

With regard to the front end, the inventive modeling tip preferably opens out in a substantially constant angle. With regard to the axis of the modeling tip, this angle for example may amount to approximately 15 degrees adjacent to the front end, i.e. the core tip.

Following the hard core tip, the area of the coating may be formed to be slightly spherical and to have a somewhat enlarged point or tip angle of for example 20 degrees.

Said area of the coating preferably merges into a cylinder area of the modeling tip in a spherical manner, which cylinder area accordingly has a point angle of 0 degrees.

Preferably a flange follows that at the same time forms a stop for the retaining ring of the coupling member. Alternatively, the stop can be configured in any other manner. A selective abutment against e.g. two or three points opposite to one another is possible as well as a conical reception area with a clamping fit, or a snap-on connection. The snap-on connection may for example be realized by flat retention edges that are formed on the shaft, on the other side of the front area, and that butt on the ring of the coupling member from behind. In case of pushing in the modeling tip into the ring, said snap-on protrusions deform slightly. Due to the spring-loaded abutment on the rear surface of the ring, a pretension arises that securely locks the modeling tip in the ring.

Nevertheless, the modeling tip can easily be removed by pressing on the shaft from behind. Preferably, the force that is necessary for unlocking the connection between the coupling member and the modeling tip, is significant, e.g. at least 50 N.

The shaft of the modeling tip is preferably provided with clamping noses that are uniformly distributed around the circumference of the shaft in a suitable number. Alternatively, knobs may be provided that may for example be retained in corresponding recesses in the ring as well.

In this respect, the invention surprisingly offers the advantage that despite the possibility to configure sophisticated anatomic structures, the adherence to composite material as well is particularly low. Surprisingly, said adherence is also not increased by the protruding core tip.

An inventive special advantage is founded in the fact that the inventive modeling tip passes through the coupling member. The protruding shaft in contrast to the state of the art permits an exertion of pressure thereon, so that an easy removal is possible. This only makes it possible to work with components with a very low coefficient of sliding friction. The coupling members with blind hole used so far require to pull out the modeling tips which is, however, made significantly more complicated due to a surface with a low coefficient of friction. The inventive solution in contrast to that is independent of it.

This, on the other hand, permits to further increase the firmness of the mounting of the modeling tip within the coupling member, which counteracts the tendency of the modeling tips to get lost upon activation and due to the shear loads applied.

It is particularly preferred that the modeling tip comprises a core that passes through the coating and that has a front end without coating. However, it is also possible to provide a coating that only partially circumferentially runs around the core, so that a nose remains that is free from a coating and that extends from the front end of the modeling tip backwards to the flange.

A solution of this kind is especially suitable for the realization by means of an injection molding technique; the injection point can then be shifted more to the rearward area so that the front end of the modeling tip is free from injection points.

It is to be understood that instead of the injection molding technique it is also possible to use any other suitable manufacturing possibilities. In this respect, the modeling tip can also be manufactured in a pressing process, and it is also possible to realize the coating or if necessary, further layers, respectively, at the will of the person skilled in the art in an immersion process or as well in a painting process.

### BRIEF DESCRIPTION OF THE DRAWINGS

Further details, advantages and features of the invention become apparent from the following description of several exemplary embodiments on the basis of the drawings, in which:

FIG. 1 shows a schematic view of an inventive dental hand tool in a perspective view;

FIG. 2 shows the coupling member as a detail of FIG. 1;

FIG. 3 shows a lateral view of a modeling tip according to the invention in one embodiment;

FIG. 4 shows the modeling tip according to FIG. 3, however in a sectional view;

FIG. 5 shows a perspective view of a modeling tip according to the invention;

FIG. 6 shows a lateral view of a further embodiment of a modeling tip according to the invention;

FIG. 7 shows the sectional view through the modeling tip according to FIG. 6;

FIG. 8 shows a schematic sectional view of a further embodiment of a modeling tip according to the invention;

FIG. 9 shows a top view of the modeling tip in the embodiment according to FIG. 8;

FIG. 10 shows a sectional view of a further embodiment of a modeling tip according to the invention; and

FIG. 11 a top view of the modeling tip according to FIG. 10, wherein the section according to FIG. 10 has been taken along the line A-A.

### DETAILED DESCRIPTION

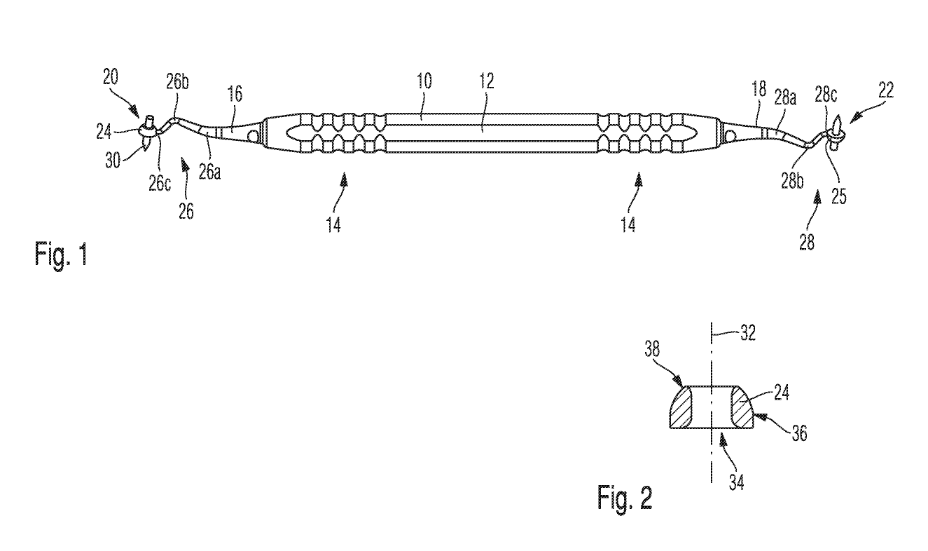

The dental hand tool 10 represented in FIG. 1 comprises a handle 12 that in a manner known per se partially carries corrugations 14. Said corrugations serve for a better grip and thus handling of the handle 12.

The dental hand tool 10 in the illustrated exemplary embodiment is formed on both sides, so that two connectors 16 and 18 extend away from the handle 12 at the respective end thereof. A coupling member 20 or 22, respectively, is coupled to the connectors 16 and 18. The coupling members 20 and 22 each comprise a ring 24 and 25, respectively. In this respect, the dental hand tool basically has a symmetrical configuration, wherein the connectors 16 and 18 each comprise an offset 26 or 28, respectively, that slightly differ from one another.

Such different offsets are known per se and serve to improve the ergonomics upon operation of the handle at poorly accessible positions within the oral cavity of the patient.

The connectors 16 and 18 comprise a substantially slightly conical construction if viewed along the run thereof. The offsets at each connector face in opposite directions in a manner known per se.

The first offset 26a in the illustrated exemplary embodiment in the drawing extends in an angle of approximately 25 degrees upwards. The second offset 26b extends in the opposite direction, again offset in an angle of 75 degrees, i.e. downwards. Immediately next to the coupling member 20, a third offset 26c is provided that in turn extends in an angle of approximately 73.5 degrees relative to the subsequent connector, and again upwards. The resulting setting angle thus amounts to 113.5 degrees with respect to the angle between the longitudinal axis of the handle 12 and the longitudinal axis 32 of the modeling tip.

It is to be understood that the mentioned angles are only exemplary. It is, however, essential for the invention to have a quite large offset of the ring 24 or 25, respectively, relative to the connector, in this case for example an angle of 70 degrees.

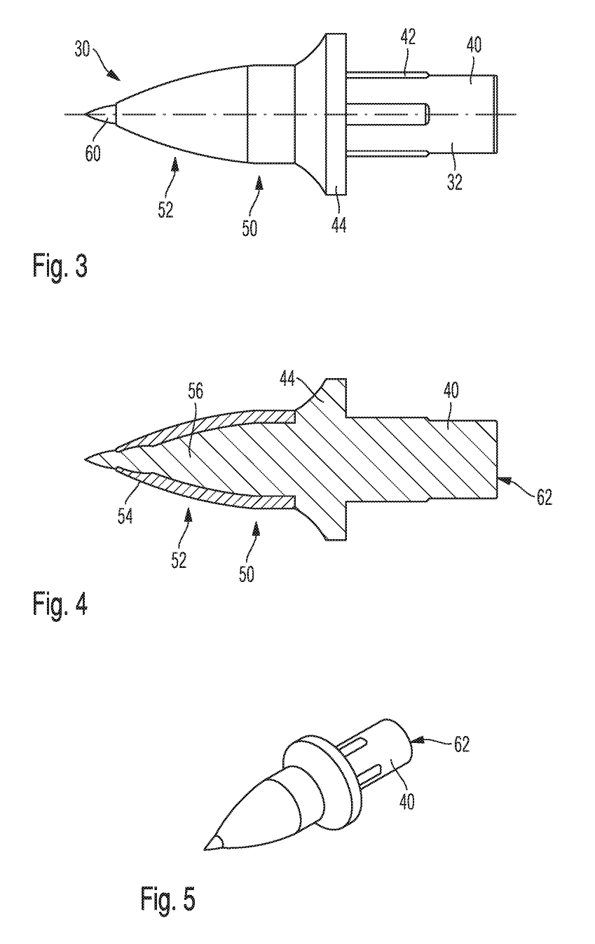

The inventive ring 24 or 25, respectively, is destined for receiving each one modeling tip 30, and namely with its shaft as illustrated in detail according to FIG. 3.

The ring 24 is illustrated magnified in FIG. 2. It comprises an axis 32 that coincides with the axis of the modeling tip and with respect to the connector 16 significantly extends inclined. The through-recess 36 of the ring is provided with radii at the ends thereof, respectively. A configuration of this kind facilitates the cleaning and where necessary the sterilization of an inventive dental hand tool as in particular no inaccessible inner corners are used.

The ring 24 comprises a spherical external shape 36 that slightly conically tapers towards the front end 38 in an inclined manner.

FIG. 3 illustrates a modeling tip 30 according to the invention in an exemplary embodiment. A shaft 40 is destined for being received within the through-recess 34 of the ring 24. In order to improve the mounting, four clamping noses 42 are provided that extend in parallel to one another. Said clamping noses 42 are destined to abut the inner surface of the ring 24 and improve the pulling-out safety.

Following the shaft 40, a flange 44 is provided whose external diameter substantially corresponds to the external diameter of the ring 24 at the front end 38. The flange 44 tapers towards its front end. Following the flange 44, a cylindrical area 50 is formed that is comparably short, for example amounts to between half or one time the size of the diameter of the shaft.

Instead of a circular flange it is also possible to form any other geometry that is suitable as a stop. For example a pin arrangement including one or several pins is suitable here which pin arrangement counteracts a translational movement of the modeling tip 30. Alternatively, a cone with a corresponding counter cone can be formed which cone is also suitable for forming a stop.

Following the cylindrical area 50, a front area 52 of the modeling tip 30 is provided.

Both the front area 52 and the cylindrical area 50 are inventively covered by a coating 54 which is illustrated in FIG. 4. The coating 54 consists of a material with a larger flexibility and a particularly low coefficient of static friction. In this connection elastomers, but also coatings of other suitable plastics such as for example polyethylene or polytetrafluoro-ethylene may be employed.

Contrary to that, the material of the remaining modeling tip 30 is harder. In this respect, it forms a core 56 relative to the coating.

The core 56 ends in a core tip 60 that passes through the coating 54—and thus the front area 52. The core tip 60 is formed conically and ends in a small radius that for example may be in between 0.01 to 0.1 mm.

While the front area 52—and partially also the cylindrical area 54 are especially suitable during the handling for pressing against the applied material and to give it a smoothed surface if applicable, the core tip (60) serves to as well produce sophisticated anatomic structures.

It is to be understood that on both sides of the inventive dental hand tool 10 it is also possible to use modeling tips 30 with different core tips; thus, the core tip could e.g. include an end radius of for example 1 mm, and accordingly include a smoothing function.

From FIG. 4 it becomes apparent that the layer thickness of the coating 54 decreases towards the front. The decrease of the layer thickness goes along with a reduction of the diameter of the modeling tip. At the position at which the modeling tip is less dimensionally stable, also the coating is less strong so that the reduction of the flexibility or resilience of the coating is compensated by the reduction of the dimensional stability.

FIG. 5 shows a perspective view of the modeling tip. The rearward end 62 of the shaft 40 is smooth and by means of it the modeling tip 30 can readily be pressed out of the ring 24.

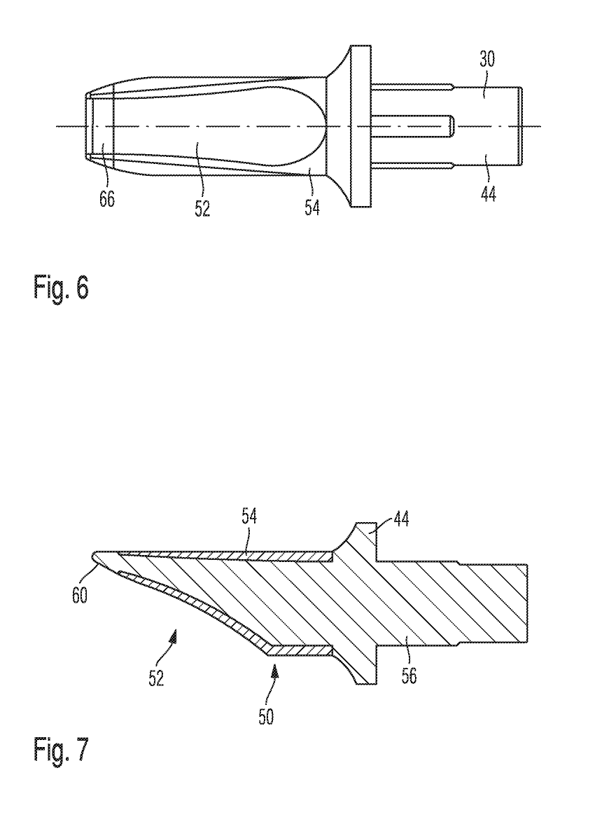

From FIGS. 6 and 7 it is exemplarily apparent in which way a modeling tip according to the invention may also be embodied. The basic form of the modeling tip 30 is chisel-shaped or spade-shaped and not circularly symmetric. The core tip 60 protrudes from the coating 54. The core tip 60 in this case forms a flat blade 66 that in specific applications is especially suitable for the modeling operation.

Identical reference numerals here and in the further figures refer to the same components and do not require any additional explanation.

It is to be understood that also in the embodiment according to the FIGS. 6 and 7, the coating in the front area 52 and also in the cylindrical area 50—that may comprise a flattening, if necessary—extends all around so that the core 56 is protected from a material contact at this position.

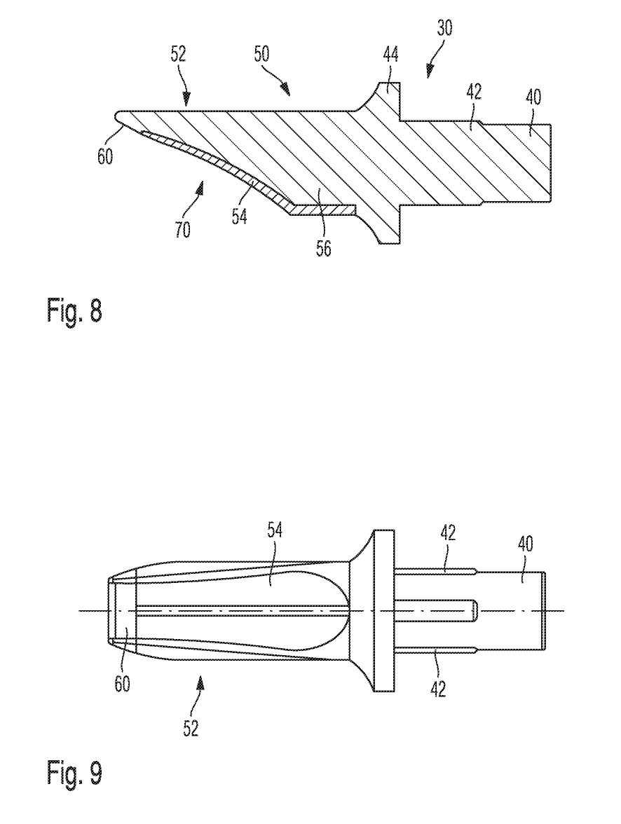

FIG. 8 shows a sectional view through a further exemplary embodiment of a modeling tip 30 according to the invention. This embodiment comprises a shaft 40 that is provided with clamping noses 42. A flange 44 follows the shaft towards the front which flange in turn is formed to circumferentially surround the shaft. A cylindrical area 50 is provided which is followed by a front area 52 of the modeling tip 30 towards the front thereof. The front area 52 substantially has a chisel shape and in so far is not circular. It tapers off to the front wherein a core tip 60 extends further to the front than a coating 54.

The modeling tip 30 consists—apart from the coating 54—of a core 56 that consists of a material that is softer or harder than the material of the coating 54.

The form of the chisel-shaped modeling tip 30 according to FIG. 8 also becomes well apparent from the comparison between FIG. 8 and FIG. 9. The coating 54 (in this embodiment) consists of either an elastomer or for example of ceramics or metal, whereas a suitable plastic material such as polyamide or polypropylene or also polyethylene, is used as a material for the core 56.

The coating 54—as it becomes apparent from FIG. 9—is provided over a side of the front area 52, and in fact over the side with the fillet or groove 70. This side is then preferably used for the non-stick adaption by the dentist wherein the fillet or groove 70 is especially well employable for the formation of spherical configurations.

The fine modeling for the representation of for example fissures on the other hand can be realized with the aid of the core tip 60

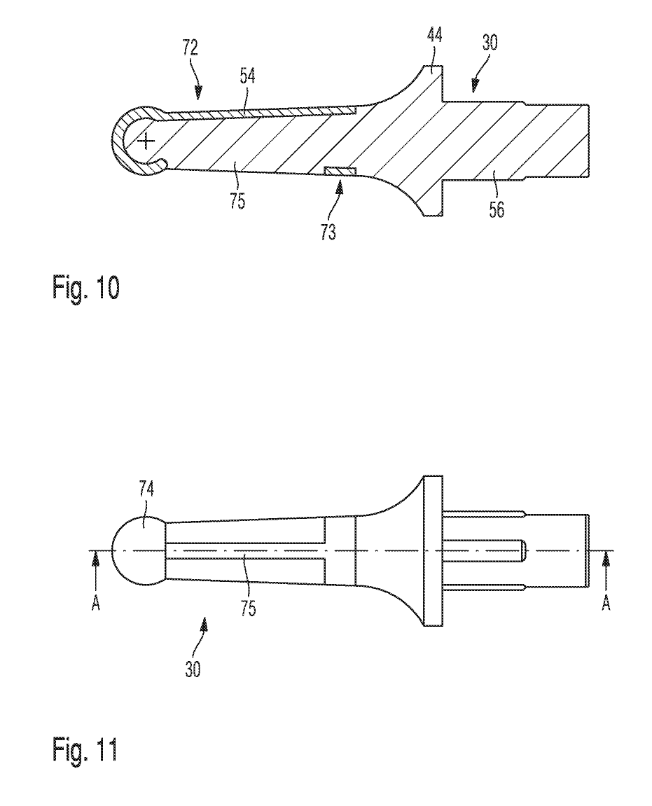

A further embodiment of a dental hand tool according to invention comprising a modeling tip 30 becomes obvious in the FIGS. 10 and 11. In this configuration, a substantially conical area 72 is provided following the flange 44. The conical area 72 comprises a coating 54. The coating 54 circularly extends in a coating ring 73, however only partially circularly following the coating ring (73) towards the front. The partial circle angle in the illustrated embodiment approximately amounts to 20 degrees, and across the remainder to 360 degrees, namely more than 340 degrees, a nose 75 protrudes from the core material 56.

Following the front, tapered end of the conical area 72 a round condenser 74 is provided. This round condenser 74 is completely surrounded by the elastomer material of the coating 54.

Said configuration of a modeling tip 30 is especially favorable for the connection with a matrix band. Matrix bands are used for the realization of rather large volume dental restorations in a manner known per se. Frequently, they consist of steel such as stainless steel.

In a favorable manner according to the invention it is now provided that the nose 75 that is free from elastomer material, slides along the matrix band when the contact point with the approximal surface is to be created. Hereby, it is safely prevented that elastomer parts may come off due to the contact with the sharp steel edge of the matrix band.

In order to also ensure this with the embodiment according to the FIGS. 8 and 9, it may be provided that the coating 54 is realized from a hard material whose flexibility or resilience is smaller than the flexibility of the material of the core 76. In case of the chisel-shaped modeling tip according to FIGS. 8 and 9, the fillet- or groove-like rear side can be employed for the sliding along the matrix band during the filling of Class II cavities.

In this respect, it is favorable to use a material with a low surface energy in this embodiment that, however, has a comparably high hardness.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A dental hand tool comprising a handle (12) with at least a connector (16) and a coupling member (20) at one end thereof, and with a second connector (18) and a second coupling member (22) at the other end of the handle (12), characterized in that a modeling tip (30) is provided that comprises a shaft and that is suitable for the coupling member, and in that the modeling tip (30) comprises a coating of a material that is more flexible compared to the remaining material of the modeling tip (30) and has a smaller surface energy of less than 35 mN/m compared to the remaining material of the modeling tip.

2. The dental hand tool as claimed in claim 1, characterized in that the connector (16, 18) is conically tapered or reduced if viewed from the handle to the coupling member (20; 22), at least along a portion of a length of the handle.

3. The dental hand tool as claimed in claim 1, characterized in that the coupling member is configured as a ring (24) having a normal that extends transversely to an axis (32) of the connector (16).

4. The dental hand tool as claimed in claim 3, characterized in that rings as coupling members (20; 22) at the two ends of the dental hand tool have different offset angles and/or different geometries of the connectors from one another and/or identical offset angles and different modeling tips (30) from one another.

5. The dental hand tool as claimed in claim 1, characterized in that the connector (16; 18) comprises at least two offsets that, if viewed sequentially with respect to their angles, face against each other, wherein the offset next to the coupling angle is oriented such that the angle between the area spanned by the coupling member (20; 22) and the adjacent connector (16; 18) is less than 90 degrees.

6. The dental hand tool as claimed in claim 1, characterized in that the modeling tip (30) having a shaft (40) passes through a ring (24) of the coupling member (20; 22) and is removable from the coupling member (20; 22) by pressing on the rearward end of the shaft (40).

7. The dental hand tool as claimed in claim 1, characterized in that a shaft of the modeling tip (30) comprises retention edges or clamping noses (42) that are destined to abut a ring (24) of the coupling member (20; 22).

8. The dental hand tool as claimed in claim 7, characterized in that the clamping noses (42) of the shaft (40) abut a ring (24) of the coupling member (20; 22) in a tight fit.

9. The dental hand tool as claimed in claim 1, characterized in that the modeling tip (30) comprises one or more protrusions, and which protrusions are destined to abut a ring (24; 26) of the coupling member (20; 22).

10. The dental hand tool as claimed in claim 1, characterized in that the modeling tip (30) comprises one or more protrusions, which protrusions separate a front area from a shaft (40) of the modeling tip (30), approximately centrally, or in such a manner that the front area of the modeling tip (30) protrudes further than the shaft (40), and/or a flange (44) of the modeling tip (30) conically tapers towards the front end of the modeling tip (30) and/or a flange (44) of the modeling tip (30) extends flush with the ring (24; 26) of the coupling member (20; 22).

11. The dental hand tool as claimed in claim 1, characterized in that the coating (54) of the modeling tip (30) covers the front area (50) of the modeling tip (30).

12. The dental hand tool as claimed in claim 1, characterized in that the coating (54) is applied to the modeling tip (30) in a manner of a sleeve and in that a core (56) of the modeling tip (30) passes through the sleeve and/or the coating (54) extends flush on the core (56) of the modeling tip (30) with continuous transitions at the ends thereof and/or the coating (54) is received in a reception area of the core (56) of the modeling tip (30), which reception area is recessed if the modeling tip (30) is represented in section.

13. The dental hand tool as claimed in claim 1, characterized in that a reception area for the coating on the modeling tip (30) conically tapers towards the front end of the modeling tip (30) and/or that the coating (54) of the modeling tip (30) extends over a cylindrical area (50) of the modeling tip (30), wherein the cylindrical area (50) is adjacent to a flange (44) of the modeling tip (30) and/or that the coating (54) extends over a conical area of the front area (50) of the modeling tip (30), and abuts a core (56) of the modeling tip.

14. The dental hand tool as claimed in claim 13, characterized in that the coating (54) over a predominant portion of its length comprises a constant thickness and conically tapers towards its front end.

15. The dental hand tool as claimed in claim 1, characterized in that a coating (54) extends around a front area (52) of a core (56) of the modeling tip (30) at least in the form of a part-ring having a wrap angle of more than 270 degrees, and that the modeling tip (30) comprises a nose (75) that extends flush with the coating (54) and extends along the front area (52).

16. The dental hand tool as claimed in claim 1, characterized in that the coating (54) extends over a front area (72) and over a core tip (74) that is formed to have a ball shape, preferably is partially ball shaped.

17. The dental hand tool as claimed in claim 1 characterized in that the coating of a material has a smaller surface energy of 29 mN/m or less, compared to the remaining material of the modeling tip.

18. The dental hand tool as claimed in claim 2, characterized in that the connector (16, 18) is conically tapered or reduced if viewed from the handle to the coupling member (20; 22), at least along more than half of its length.

19. The dental hand tool as claimed in claim 5, characterized in that the connector (16; 18) comprises at least three offsets.

20. The dental hand tool as claimed in claim 8, characterized in that the clamping noses (24) and/or the shaft (40) deform in a coupled condition, or that the shaft (40) is formed to have a conical shape and the ring (24) comprises a matching countercone.

21. The dental hand tool as claimed in claim 9, characterized in that the modeling tip (30) comprises a flange (44), which flange is formed so as to circumferentially run around the tip.

22. The dental hand tool as claimed in claim 10, characterized in that the one or more protrusions comprise a flange (44) or protruding pins.

23. The dental hand tool as claimed in claim 11, characterized in that the coating (54) of the modeling tip (30) covers a portion of the length of the modeling tip (30), and/or in that the modeling tip (30) comprises a core (56) that is covered by a large portion of the front area (50) of the coating (54).

24. The dental hand tool as claimed in claim 16, characterized in that the coating (54) extends over a front area (72) and over a core tip (74) that is formed to have a partially ball shape.
